(19) United States
(12) Patent Application Publication
(10) Pub. No.: US 2026/0037228 A1
(43) Pub. Date: Feb. 5, 2026

(54) PROGRAM CREATION DEVICE AND NON-TRANSITORY COMPUTER-READABLE STORAGE MEDIUM STORING COMPUTER PROGRAM

(71) Applicant: SEIKO EPSON CORPORATION, Tokyo (JP)

(72) Inventor: Hiroki NODA, AZUMINO-SHI (JP)

(21) Appl. No.: 19/288,847

(22) Filed: Aug. 1, 2025

(30) Foreign Application Priority Data
Aug. 5, 2024 (JP) 2024-128810

(51) Int. Cl. G06F 8/30

(52) U.S. Cl. CPC G06F 8/30

(57) ABSTRACT

A program creation device causes a display device to display an editing region in which a source code of a program is edited, and a library creation region in which a library is created by packaging the source code and is associated with a manual. The library creation region includes a manual reference region in which a manual associated with the created library is designated. A processing device further causes the display device to display a library addition region in which a previously created library is added to a new program in which the source code is edited, and a manual call region in which a manual associated with the previously created library is called.

### CROSS-REFERENCE TO RELATED APPLICATIONS

The present application is based on, and claims priority from JP Application Serial Number 2024-128810, filed Aug. 5, 2024, the disclosure of which is hereby incorporated by reference herein in its entirety.

### BACKGROUND OF THE INVENTION

### 1. Technical Field

The present disclosure relates to a program creation device and a non-transitory computer-readable storage medium storing a computer program.

### 2. Related Art

In the related art, there is a program creation device that uses a library. A control program creation device of JP-A-2011-170419 creates a control program from a standard library affiliated therewith and a source code stored by a user. The standard library includes a modularized standard function. In a control program creation device of JP-A-2011-170419, since a standard function is modularized in the standard library, it is easy to reuse a specific control process.

The control program creation device of JP-A-2011-170419 further creates a supplemented standard library in which a standard library is supplemented with a standard function in a standard library subset. The control program creation device of JP-A-2011-170419 creates a control program by compilation using the supplemented standard library and the source code. According to a technology of JP-A-2011-170419, even in a control program creation device of an old version, by supplementing a missing standard function from the standard library subset, the control program can be created again from a user file. As a result, a control process can be maintained in a situation where it is difficult to obtain the latest control program creation device.

In a technology described in JP-A-2011-170419, when a library in a standard library subset is a library created by a person other than a person who creates a control program by using a control program creation device, following problems occur. That is, the person who creates the control program cannot easily identify a function, a usage method, and the like of the library.

### SUMMARY OF THE INVENTION

The present disclosure aims to address at least a part of the above-described problems and can be realized in the following form.

According to the present disclosure, a program creation device is provided. The program creation device includes a display device displaying a screen, an input device to which information is input by a user, and a processing device generating a screen according to the input information and causing the display device to display the screen. The processing device causes the display device to display an editing region through which a source code of a program is edited, and a library creation region through which a library is created by packaging the edited source code and in which the created library is associated with a manual. The library creation region includes a manual reference region through which the manual associated with the created library is designated. The processing device further causes the display device to display a library addition region through which a previously created library is added to a new program including an edited source code, and a manual call region through which a manual associated with the previously created library is called.

### BRIEF DESCRIPTION OF DRAWINGS

FIG. 1 is a block diagram illustrating a robot system of the present disclosure.

FIG. 2 is a diagram illustrating an example of an entire display region and an editing region included in a screen displayed on a display device.

FIG. 3 is an explanatory diagram illustrating a state in which a “project (P)” tab is opened.

FIG. 4 is a diagram illustrating an example of a library creation region.

FIG. 5 is a diagram illustrating a library created and stored in an HDD of a personal computer.

FIG. 6 is a diagram illustrating a process when a library created previously is added to a new program in which source code is edited.

FIG. 7 is a diagram illustrating an example of a library addition region.

FIG. 8 is a diagram illustrating an example of the library addition region after a library is registered.

FIG. 9 is a diagram illustrating an example of the entire display region and the editing region after the library addition region is closed.

FIG. 10 is an explanatory diagram illustrating a process of displaying a screen displayed when a program is executed in a case where a library is used in the program.

FIG. 11 is an explanatory diagram illustrating a screen displayed when a program is executed in a case where a library is used in the program.

FIG. 12 is a diagram illustrating a process when a manual associated with the library is called through a manual call region.

FIG. 13 illustrates a screen displayed on the display device.

### DETAILED DESCRIPTION OF THE INVENTION

### A. First Embodiment

### A1. Configuration of Robot System 1

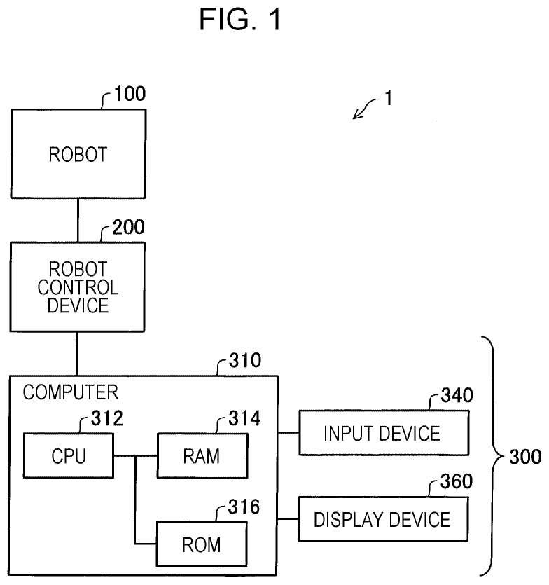

FIG. 1 is a block diagram illustrating a robot system 1 of the present disclosure. The robot system 1 includes a robot 100, a robot control device 200, and a program creation device 300. The robot 100 and the robot control device 200 are connected to each other to be able to perform information communication. The robot control device 200 and the program creation device 300 are connected to each other to be able to perform information communication. In the robot system 1, the robot control device 200 receives a program created by the program creation device 300 from the program creation device 300, and operates the robot 100 according to the program.

The program creation device 300 creates a program for operating the robot 100 and transmits the program to the robot control device 200. The program creation device 300 includes a personal computer 310, an input device 340, and a display device 360.

The input device 340 is a device to which the program creation device 300 inputs information from a user. The input device 340 is specifically a keyboard and a mouse. An example of the information input from the user includes character information input through a keyboard and information indicating a specific item selected by the user on a screen through a mouse. The display device 360 displays a screen. In the present specification, the “screen” is an image indicated to the user by a display device, and is an image that occupies a part or all of a region in which an image can be displayed by the display device. The display device 360 is specifically a liquid crystal display.

The personal computer 310 creates a program according to the information input from the input device 340, and transmits the program to the robot control device 200. The personal computer 310 includes a central processing unit (CPU) 312 which is a processor, a random access memory (RAM) 314, and a read only memory (ROM) 316. The RAM 314 includes a main memory which is a semiconductor memory, a solid state drive (SSD), and a hard disk drive (HDD). The CPU 312 loads a computer program stored in the ROM 316 and the SSD or HDD into a main memory and executes the computer program to realize various functions. The CPU 312 generates a screen according to information input through, for example, the input device 340, and causes the display device 360 to display the screen.

### A2. Operation of Robot System 1

### (1) Editing of Source Code

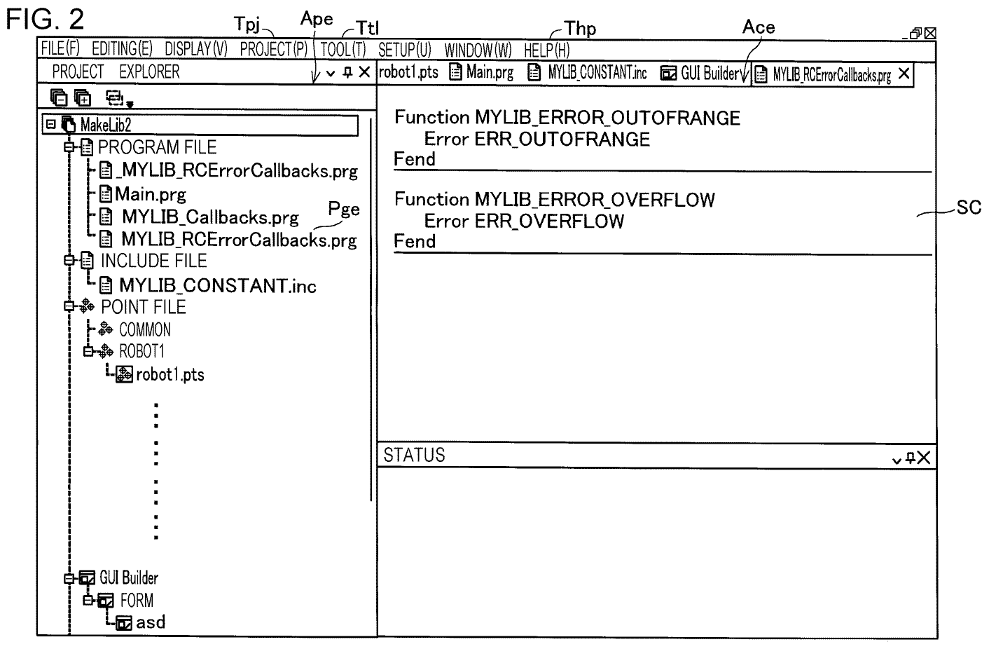

FIG. 2 is a diagram illustrating an example of an entire display region Ape and an editing region Ace included in a screen displayed on the display device 360. When a computer program for creating a program for operating a robot is executed by the CPU 312, a screen of FIG. 2 is displayed on the display device 360. The computer program for creating the program for operating the robot is also referred to as a “robot integrated development environment”. FIGS. 2 to 13 illustrate a screen or a part of the screen displayed on the display device 360 when the robot integrated development environment is executed (refer to a lower right portion in FIG. 1). The entire display region Ape and the editing region Ace are created by the CPU 312 and displayed on the display device 360.

In the entire display region Ape, a plurality of components used when a program is created are displayed in tree structures (refer to a left portion of FIG. 2). The plurality of components used when the program is created include, for example, a program file, an include file, a library, and the like. A function of realizing the entire display region Ape is also referred to as a “project explorer” (refer to an upper left portion in FIG. 2).

A source code SC of the program is edited through the editing region Ace (refer to an upper right portion in FIG. 2). The program in which the source code SC is edited may include, for example, a function, a variable, a screen to be displayed, and the like. In the example of FIG. 2, a source code of a program Pge having a name of “MYLIB_RCErrorCallbacks.prg” among program files illustrated in the entire display region Ape is edited (refer to an upper left portion and upper right portion of FIG. 2). Processing performed when the library LB1 is created by packaging the program Pge will be described below.

### (2) Creation of Library

In a state of FIG. 2, tabs such as a “project (P)” tab Tpj, a “tool (T)” tab Ttl, and a “Help(H)” tab Thp are displayed on an upper portion of a screen. Each tab is created by the CPU 312 and is displayed on the display device 360. Each tab is also referred to as a “menu”. In the state of FIG. 2, when the “project (P)” tab Tpj is clicked, the “project (P)” tab Tpj is opened (refer to an upper center portion in FIG. 2).

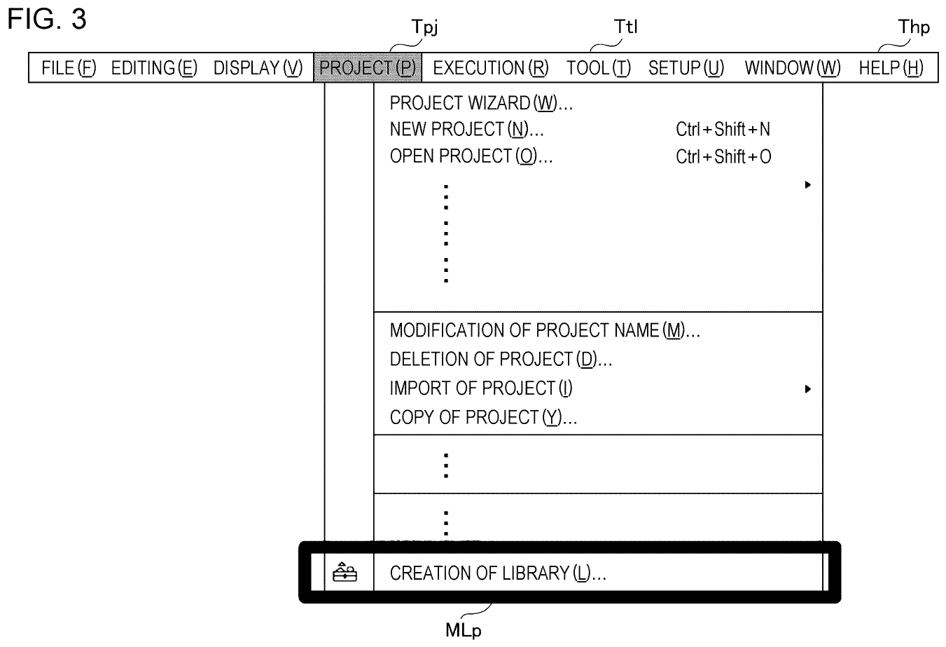

FIG. 3 is an explanatory diagram illustrating a state in which the “project (P)” tab Tpj is opened. FIG. 3 is a diagram illustrating a state in which the “project (P)” tab Tpj is opened, and a state of the screen behind the “project (P)” tab Tpj does not reflect the state of FIG. 1. When the “creation of library (L)” menu MLp displayed at the bottom of the opened “project (P)” tab Tpj is selected, the library creation region ALp is opened (refer to a lower portion of FIG. 3). In FIG. 3, a frame is drawn around the “creation of library (L)” menu MLp to emphasize the “creation of library (L)” menu MLp. However, the frame is not displayed on an actual display screen.

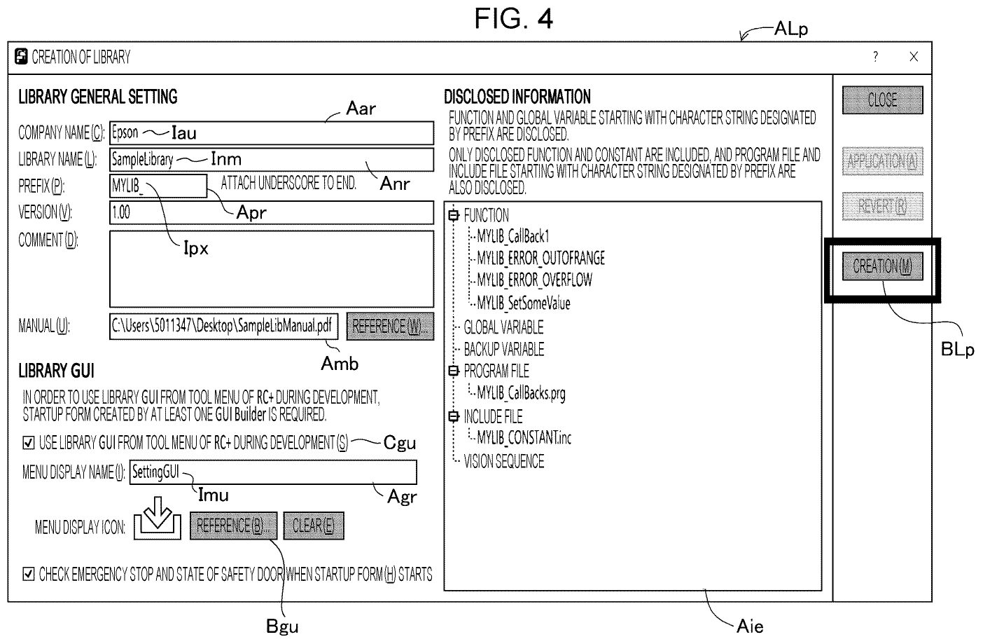

FIG. 4 is a diagram illustrating an example of the library creation region ALp. The library creation region ALp is created by the CPU 312 and is displayed on the display device 360. The library LB1 is created by packaging the source code SC edited in the editing region Ace through the library creation region ALp. Further, the created library LB1 and the manual Mnl thereof are associated with each other through the library creation region ALp.

The library creation region ALp includes a creator information input window Aar, a library name input window Anr, a prefix input window Apr, a manual reference region Amb, a GUI checkbox Cgu, a menu display name input window Amr, a GUI designation button Bgu, an information disclosure region Aie, and a library creation button BLp.

The creator information input window Aar is a region that receives creator information Iau (refer to an upper left portion in FIG. 4). The creator information Iau relates to a creator who creates a library through the library creation region ALp. The creator information Iau is input to the program creation device 300 through the input device 340. Similarly, the information received by each input window is input to the program creation device 300 through the input device 340. In the example of FIG. 4, the creator information Iau represents a name of a company to which a creator who creates a library belongs.

The library name input window Anr is a region that receives a library name Inm (refer to an upper left portion in FIG. 4). The library name Inm is attached to each library to distinguish each library to be created. In the example of FIG. 4, the library name Inm is “SampleLibrary”.

The prefix input window Apr is a region that receives a prefix Ipx (refer to an upper left portion in FIG. 4). The prefix Ipx is a character string commonly attached to the beginning of the name of a variable or a program used in a library to be created. In the example of FIG. 4, the prefix Ipx is “MYLIB_”.

The manual Mnl to be associated with the library LB1 created in the library creation region ALp is designated through the manual reference region Amb (refer to a middle left portion in FIG. 4). In the present embodiment, a path of a data file of the manual Mnl stored in an HDD of the personal computer 310 is designated. Here, it is assumed that the data file of the manual Mnl is created previously. A list of functions included in the library, the functions, and functions and a usage method of the functions are described in the manual Mnl. The manual Mnl may include a drawing in addition to characters and symbols. The manual Mnl may be stored as a plurality of file formats such as a pdf format file, a jpg format file, a png format file, an html format file, and a txt format file.

By performing such processing, a user who edits the source code SC of a program using the program creation device 300 can designate the manual Mnl through the manual reference region Amb when creating the library LB1 by packaging the source code SC. Then, the user can associate the created library LB1 with the manual Mnl thereof through the library creation region ALp.

The GUI checkbox Cgu is a checkbox for selecting whether or not to use the GUI from a tool menu when the library created in the library creation region ALp is added to another program later (refer to a lower left portion in FIG. 4).

The menu display name input window Amr is a region that receives a menu display name Imn (refer to a lower left portion in FIG. 4). The menu display name Imn is a name displayed in the tool menu when the library created in the library creation region ALp is added to another program later. In the example of FIG. 4, the menu display name Imn is “Setting GUI”.

The GUI designation button Bgu is a button for designating an image of an icon displayed in the tool menu when the library created in the library creation region ALp is added to another program later (refer to a lower left portion in FIG. 4). By pressing the GUI designation button Bgu, an interface for designating an image file in an HDD or an SSD of the personal computer 310 as an icon image is displayed. The image file representing the image of the icon may be stored in a plurality of file formats such as a jpg format file and a png format file.

In the information disclosure region Aie, a function or variable starting with the prefix Ipx input to the prefix input window Apr is disclosed (refer to a right portion in FIG. 4). When the library created in the library creation region ALp is added to another program later, the function and the variable disclosed in the information disclosure region Aie can be used by being called from the program to which the library is added.

When the library creation button BLp is clicked, the program in which the source code SC is edited in the editing region Ace is packaged according to the information input to each input window of the library creation region ALp, and a library is created (refer to a middle right portion in FIG. 4). In FIG. 4, a frame is drawn around the library creation button BLp to emphasize the library creation button BLp. However, the frame is not displayed on an actual display screen.

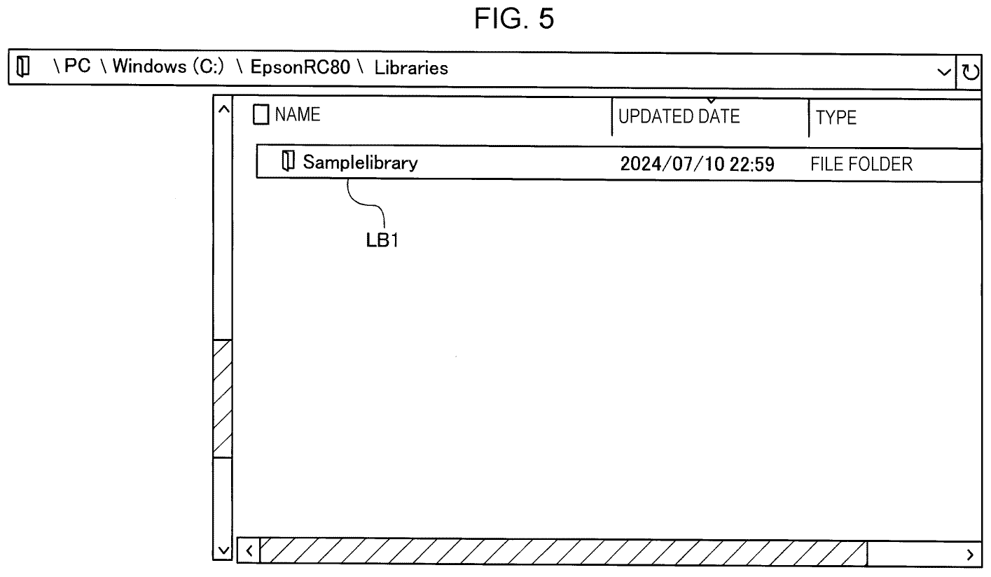

FIG. 5 is a diagram illustrating the library LB1 created and stored in the HDD of the personal computer 310. In the example of FIG. 5, a folder of the library LB1 named “SampleLibrary” is created in a folder called “\Windows(c:)\EpsonRC80\Libraries” in the HDD of the personal computer 310 (refer to an upper portion of FIG. 5). When the manual Mnl is associated with the library LB1, a file of the manual Mnl is stored in the same folder as a folder in which the library LB1 is stored in the personal computer 310 (refer to Amb in FIG. 4).

### (3) Use of Library

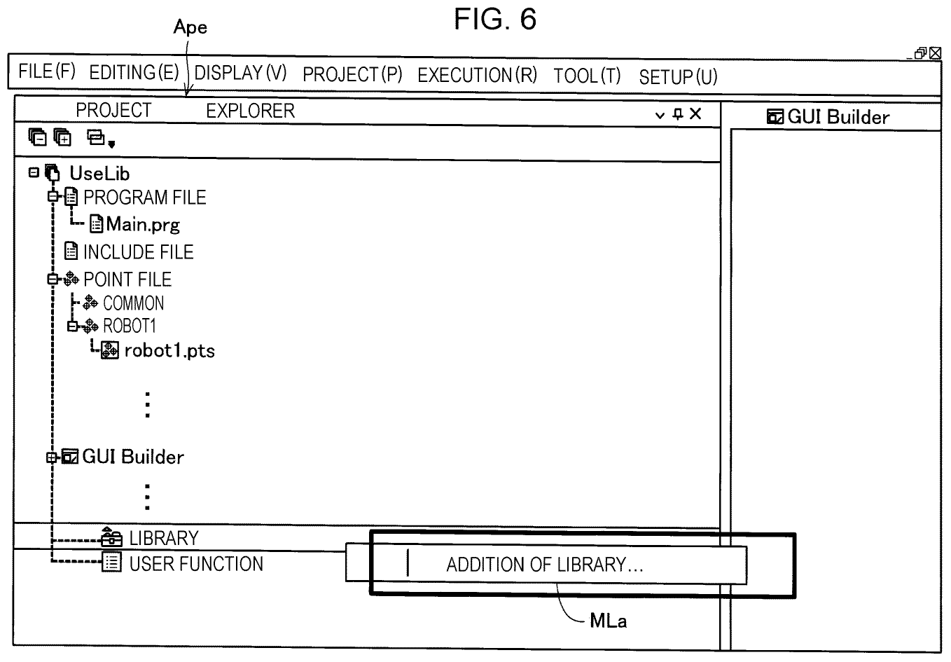

FIG. 6 is a diagram illustrating a process when a library created previously is added to a new program being created. In the entire display region Ape, when a cursor is placed over a display of “Library” and a right click is performed, an “addition of library” menu MLa appears (refer to a lower portion of FIG. 6). When the “addition of library” menu MLa is clicked, the library addition region ALa is displayed. In FIG. 6, a frame is drawn around the “addition of library” menu MLa to emphasize the “addition of library” menu MLa. However, the frame is not displayed on an actual display screen.

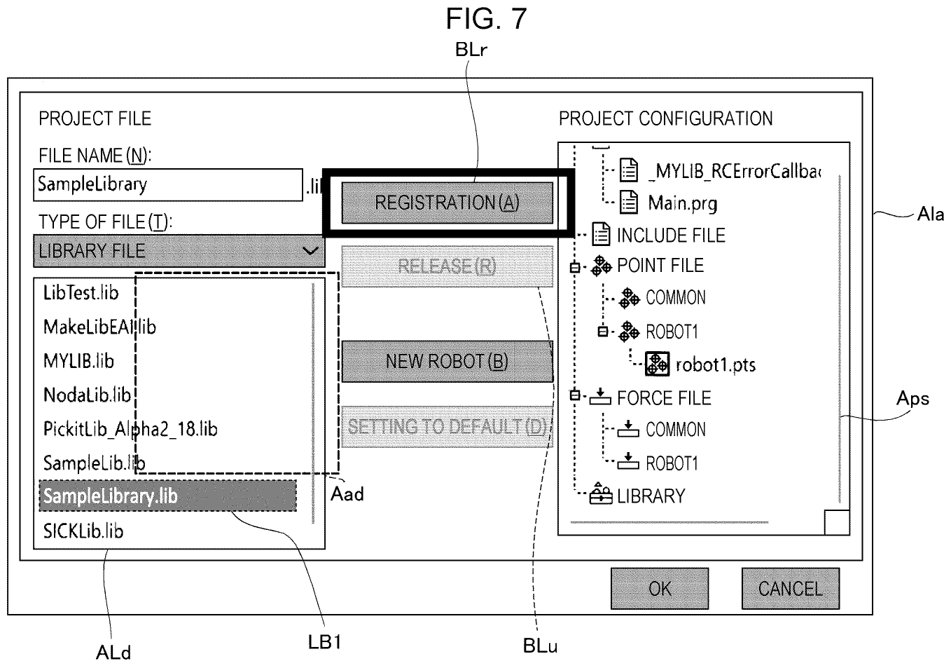

FIG. 7 is a diagram illustrating an example of the library addition region ALa. The library addition region ALa is created by the CPU 312 and is displayed on the display device 360. A library created previously is added to a new program in which a source code is edited through the library addition region ALa. The library addition region ALa includes a library display region ALd, a library registration button BLr, a library release button BLu, and a project display region Aps.

In the project display region Aps, a configuration of the program being created is illustrated in tree structures (refer to a right portion in FIG. 7). A program for operating the robot 100 is also referred to as a “project”. One project often corresponds to one work of the robot 100. However, one project may correspond to a plurality of works of the robot 100. In the example of FIG. 7, nothing is displayed under the display of “library” in the project display region Aps.

In the library display region ALd, one or more libraries created previously are displayed (refer to a lower left portion in FIG. 7). In the example of FIG. 7, the library LB1 having a file name called “SampleLibrary.lib” in the library display region ALd is selected.

When a right click is performed as an operation on the library addition region ALa in a state where the library LB1 is selected, a menu for instructing the display of a region Aad displaying information on the library LB1 may be displayed. When the display of the region Aad for displaying the information on the library LB1 is instructed, the region Aad is displayed. The region Aad displays creator information Iau of the library LB1. The region Aad further displays the prefix Ipx, the menu display name Imn, and the like of the library LB1 (refer to a left portion in FIG. 4). In FIG. 7, an example of a position in which the region Aad displaying the information on a library is displayed is illustrated by a dashed line (refer to a middle left portion in FIG. 7).

By performing such processing, a user who edits the source code SC of a program using the program creation device 300 can add the library to a program in which the source code SC is edited through the library addition region ALa after checking the information on the library such as a creator and the like of the library to be added.

When the library registration button BLr is pressed in a state where the library LB1 in the library display region ALd is selected, the selected library LB1 is added to the program being edited. In FIG. 7, a frame is drawn around the library registration button BLr to emphasize the library registration button BLr. However, the frame is not displayed on an actual display screen.

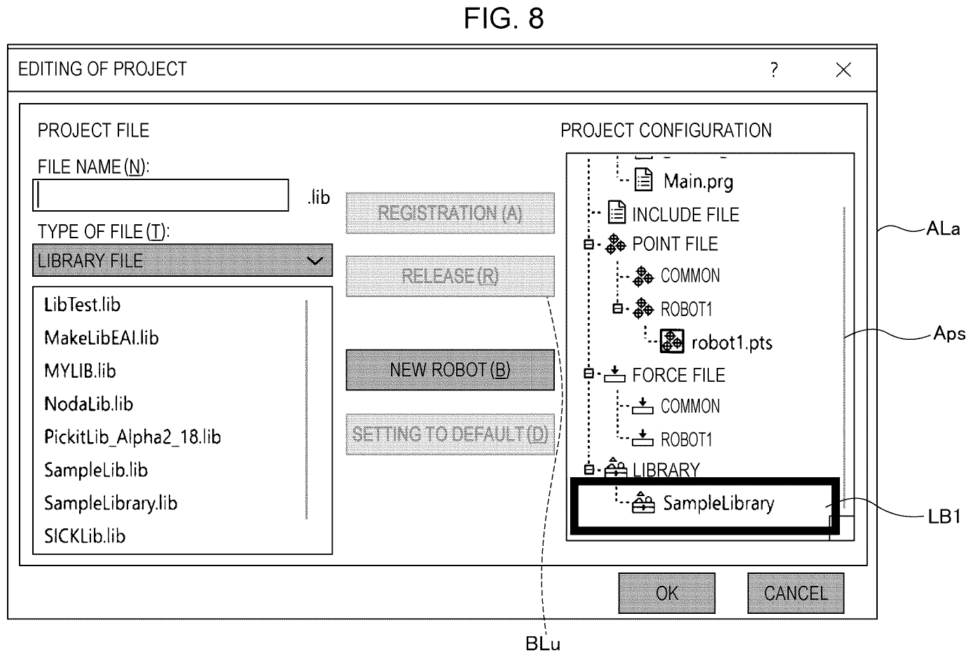

FIG. 8 is a diagram illustrating an example of the library addition region ALa after the library is registered. In the example of FIG. 8, “SampleLibrary” which is a name of the registered library LB1 is displayed under the display of “library” in the project display region Aps (refer to a lower right portion in FIG. 8). In FIG. 8, a frame is drawn around the name “SampleLibrary” of the library LB1 to emphasize the name “SampleLibrary” of the registered library LB1. However, the frame is not displayed on an actual display screen.

In FIGS. 7 and 8, the library release button BLu is grayed out and can not be used. However, in a state where the library LB1 displayed in the project display region Aps is selected, the library release button BLu can be turned on. When the library release button BLu is turned on, the addition of a program being edited in the library selected in the project display region Aps at that time is released. That is, a library can be added to and released from the program being edited through the library addition region ALa.

After registering a necessary library, a program creator presses an “OK” button in the library addition region ALa to close the library addition region ALa (refer to a lower right portion in FIG. 8).

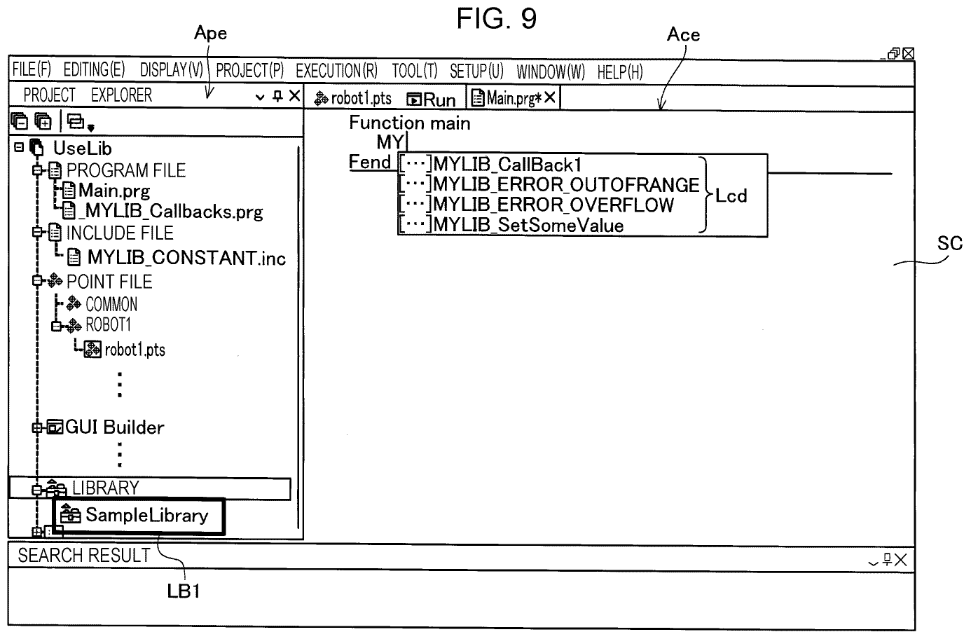

FIG. 9 is a diagram illustrating an example of the entire display region Ape and the editing region Ace after the library addition region ALa is closed. In the entire display region Ape, “SampleLibrary”, which is a name of the registered library LB1, is displayed under the display of “Library” (refer to a lower left portion in FIG. 9). In FIG. 9, a frame is drawn around the name “SampleLibrary” of the library LB1 to emphasize the name “SampleLibrary” of the registered library LB1. However, the frame is not displayed on an actual display screen.

When a right click is performed in a state where the library LB1 displayed in the entire display region Ape is selected, a menu including the library release button BLu is displayed. By selecting the library release button Blu from the menu, addition of the selected library to a program being edited is released.

In the example of FIG. 9, the source code SC of a program Main.prg is edited in the editing region Ace (refer to an upper center portion in FIG. 9). In the editing region Ace, since “MY” is input by a user, “Lcd” is illustrated as a candidate of a predicted input.

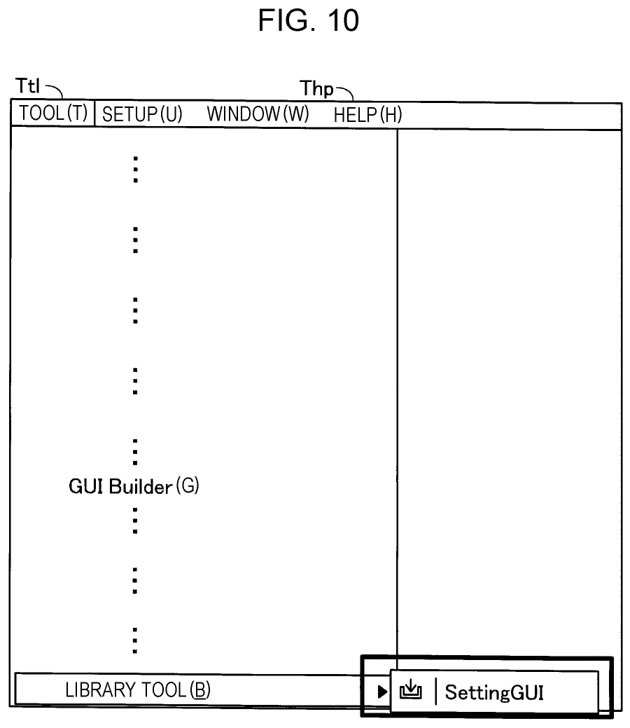

FIG. 10 is an explanatory diagram illustrating a process of displaying a screen displayed during display of a program when a library is used in the program. After the library LB1 is registered, when a “tool (T)” tab Ttl is clicked, the “tool (T)” tab Ttl is opened. When a cursor is placed over a “library tool (B)” menu displayed at the bottom of the open “tool (T)” tab Ttl, a menu name and an icon of the registered library are displayed (refer to a lower right portion in FIG. 10). The displayed menu name is a menu display name Imn input to the menu display name input window Amr in the library creation region ALp (refer to a lower left portion in FIG. 4). In the example of FIG. 4, the displayed menu name is “Setting GUI”. The displayed icon is an icon designated by a GUI designation button Bgu in the library creation region ALp (refer to a lower left portion in FIG. 4).

When the displayed menu display name Imn is selected, and when a library is used in the program, a screen Agu displayed during execution of a program is displayed. The screen Agu is created by the CPU 312 and is displayed on the display device 360. The screen Agu displayed during execution of the program when the library is used in the program can include, for example, an input window, a button, and an icon. When the program being created is executed, a parameter related to an operation of a robot is input from a user through the screen Agu. In FIG. 10, a frame is drawn around an icon and a menu display name Imn “Setting GUI” to emphasize the icon and the menu display name Imn “Setting GUI”. However, the frame is not displayed on an actual display screen.

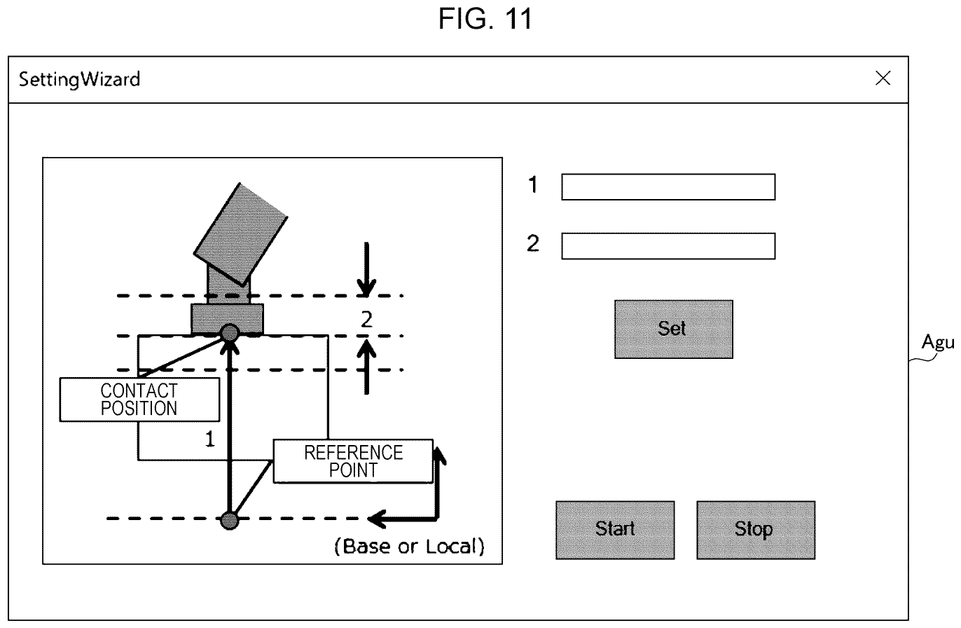

FIG. 11 is an explanatory diagram illustrating a screen displayed during execution of a program when a library is used in the program. When a function of the library LB1 is realized in a program, the screen Agu illustrated in FIG. 11 is displayed as a user interface.

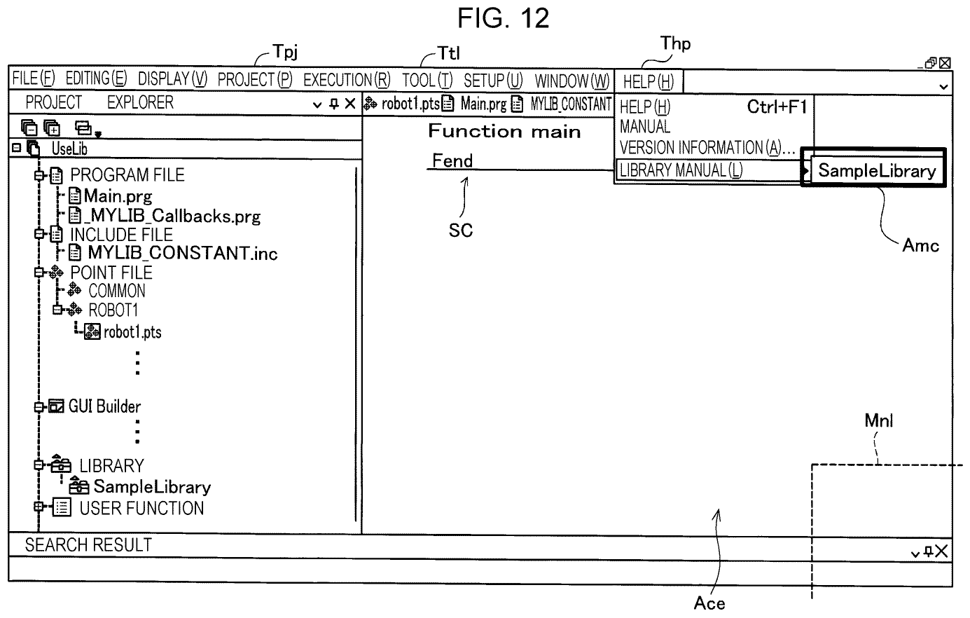

FIG. 12 is a diagram illustrating processing when the manual Mnl associated with the previously created library LB1 is called through a manual call region Amc. In a state where the editing region Ace is displayed, a “Help(H)” tab Thp is displayed (refer to an upper right portion in FIG. 12 and an upper center portion in FIG. 2). The “Help(H)” tab Thp is a user interface for displaying information on a function used when a program is created by using a robot integrated development environment in the program creation device 300. The “Help(H)” tab Thp is created by the CPU 312 and is displayed on the display device 360. In the state of FIG. 2, when the “Help(H)” tab Thp is clicked, the “Help(H)” tab Thp is opened (refer to an upper right portion in FIG. 12).

FIG. 12 illustrates a state in which the “Help(H)” tab Thp is opened. FIG. 12 is a diagram illustrating a state in which the “Help(H)” tab Thp is opened, and a state of a screen behind the “Help(H)” tab Thp does not reflect the state of FIG. 2.

When a “Manual” menu displayed in an upper portion of the opened “Help(H)” tab Thp is selected, a manual of a robot integrated development environment is displayed (refer to an upper right portion in FIG. 12).

Meanwhile, when a “library manual (L)” menu displayed at the bottom of the opened “Help(H)” tab Thp is selected, a name Amc of a library registered and associated with a manual is displayed. In the example of FIG. 12, the name Amc of the displayed library is only “SampleLibrary”. The displayed name is the library name Inm input to the library name input window Anr of the library creation region ALp (refer to an upper left portion in FIG. 4). The display Amc of the name of the library displayed according to an operation on the “Help(H)” tab Thp is also referred to as a “manual call region Amc” in the present specification. The manual call region Amc is created by the CPU 312 and is displayed on the display device 360. In FIG. 12, a frame is drawn around the displayed library name “SampleLibrary” to emphasize the displayed library name “SampleLibrary”. However, the frame is not displayed on an actual display screen.

When the displayed library name “SampleLibrary” is clicked, the manual Mnl associated with the library LB1 of the library name “SampleLibrary” is displayed. That is, the manual Mnl associated with the previously created library LB1 edited in the editing region Ace is called through the display Amc of the library name. Specifically, a file of the manual Mnl in a folder in which the library LB1 is stored in the personal computer 310 is read.

By performing the processing described with reference to FIG. 12, a user can select the “manual” menu in the “Help(H)” tab Thp, that is, display the manual call region Amc on the display device 360 by the same operation as an operation when referring to information on a function used in creating a program according to a robot integrated development environment, thereby calling the manual Mnl.

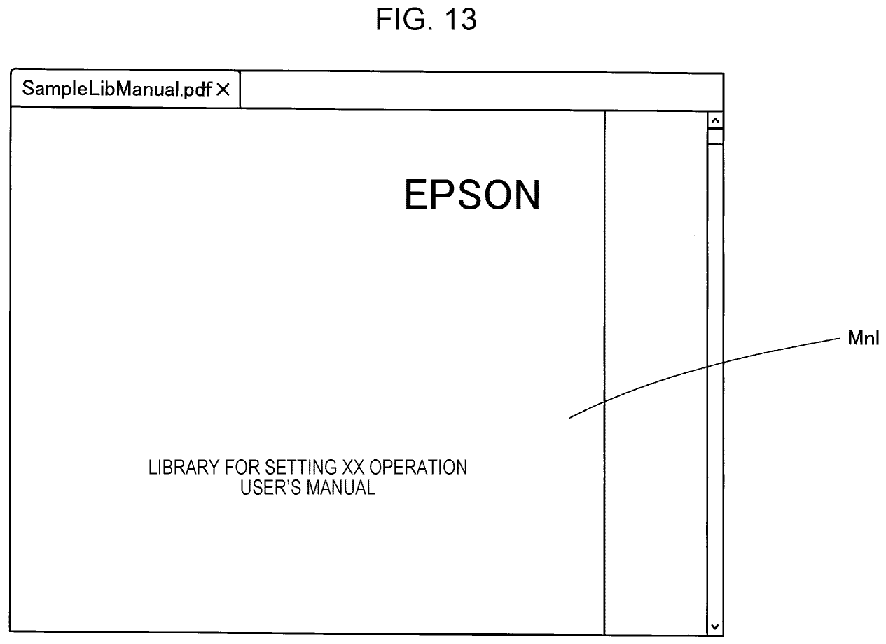

FIG. 13 is a diagram illustrating a state in which the manual Mnl is displayed. An image of the manual Mnl is created by the CPU 312 and is displayed on the display device 360. More specifically, the CPU 312 displays the manual Mnl on the display device 360 together with the editing region Ace when an instruction to call the manual Mnl is received through the display Amc of a name of a library in a state where the editing region Ace is displayed on the display device 360. The manual Mnl is displayed in a window different from a window including the editing region Ace, together with a part of the window including the editing region Ace, and overlaps another part of the window including the editing region Ace. In FIG. 12, a position of the manual Mnl displayed to overlap a part of the editing region Ace is illustrated by a dashed line.

By performing such display, a user who edits the source code SC of a program using the program creation device 300 can perform the editing of the source code SC and browsing of the manual Mnl in parallel. Further, since parts of a window overlaps each other, the user who edits the source code SC can browse the manual Mnl in a small movement of a line of sight from a state of viewing the editing region Ace for editing the source code SC.

A user who edits the source code SC of a program using the program creation device 300 of the present embodiment can call the manual Mnl associated with the library LB1 through the manual call region Amc. In other words, a user can browse the manual Mnl in a robot integrated development environment without opening and browsing a manual as a printed matter and without separately reproducing and browsing a data file of the manual stored in a storage medium. Then, a user can add the library to a program in which the source code SC is edited through the library addition region ALa after reading the manual Mnl and understanding a function and a usage method of the library LB1.

The CPU 312 of the present embodiment is also referred to as a “processing device”. The “Help(H)” tab Thp is also referred to as a “help tab”.

### B. Other Embodiments

### B1. Another Embodiment 1

(1) In the above-described embodiment, the program creation device 300 includes the personal computer 310, the input device 340, and the display device 360 (refer to a lower portion in FIG. 1). However, the program creation device 300 may be a pendant that can create a program for operating the robot 100, or may be a tablet type computer. The display device 360 may be an organic electro-luminescence (EL) display.

(2) In the above-described embodiment, the creator information Iau is a name of a company to which a creator who creates a library belongs (refer to an upper left portion in FIG. 4). However, the creator information may be a name of a natural person who creates a library, or may be a name of some organization related to the natural person who creates the library.

(3) In the above-described embodiment, the manual Mnl describes a list of functions included in a library, functions and a usage method of the functions, and the like. The manual Mnl may include other information such as a name of a natural person who is a creator of a library, a name of an organization to which the natural person belongs, and a condition under which use of a library is permitted, together with or instead of the manual. That is, the manual may include any information related to the library.

(4) In the above-described embodiment, the manual Mnl is stored in a plurality of file formats such as a pdf format file, a jpg format file, a png format file, an html format file, and a txt format file. A file in which information of the manual Mnl in the program creation device 300 is stored may be, for example, a file in which a link representing a place outside the personal computer 310 in which a data file of the manual Mnl is stored is recorded.

(5) In the above-described embodiment, when the manual Mnl is associated with the library LB1, a file of the manual Mnl is stored in the same folder as a folder in which the library LB1 is stored in the personal computer 310 (refer to Amb in FIG. 4 and FIG. 5). However, a data file of a manual associated with a library may be stored in a folder different from the library in a program creation device, or may be stored in another device connected to the program creation device to be able to perform information communication. Further, the data file may be stored in a medium that is readable by a program creation device and/or a medium that is readable by another device connected to the program creation device such that information can be communicated. Further, the manual and the library may be stored in the same file form.

(6) In the program creation device 300 of the above-described embodiment, when the “creation of library (L)” menu MLp of the “project(P)” tab Tpj is selected, the library creation region ALp is opened (refer to a lower center portion in FIG. 3). However, the program creation device may not have a function of creating a library, and may have an aspect in which an existing library can be added to a program being created.

(7) In the above-described program creation device 300, a part of the entire display region Ape, the editing region Ace, the library creation region ALp, the manual reference region Amb, the library addition region ALa, and the manual call region Amc is displayed at the same time, and the other parts are not displayed at the same time. However, these regions may be displayed all at the same time, may be displayed all in sequence, or a part may be displayed at the same time, and another part may be displayed in sequence, depending on an instruction from a user.

### 2. Another Embodiment 2

In the above-described embodiment, in a state where the editing region Ace is displayed, when the “library manual (L)” menu in the “Help(H)” tab Thp is selected, the manual call region Amc is displayed (refer to an upper right portion in FIG. 12). However, a manual call region may be displayed through another operation such as performing right click on the editing region Ace.

### B3. Another Embodiment 3

In the above-described embodiment, the creator information Iau is input to the creator information input window Aar of the library creation region ALp (refer to an upper left portion in FIG. 4). The creator information Iau is information input through the input device 340 and is information on a creator who creates a library through the library creation region ALp. Then, in the library display region ALd of the library addition region ALa, when the right click is performed as an operation on the library addition region ALa in a state where the library LB1 is selected, the region Aad for displaying the information on the library LB1 is displayed (refer to a middle left portion in FIG. 7). The region Aad displays creator information Iau of the library LB1.

The region Aad including the creator information Iau of the library LB1 may be displayed according to another operation, such as a case where right click is performed as an operation on the library addition region ALa in a state where the library LB1 is selected in the project display region Aps or the entire display region Ape (refer to FIG. 7).

### 4. Another Embodiment 4

In the above-described embodiment, when the CPU 312 receives an instruction to call the manual Mnl through the display Amc of a name of a library in a state where the editing region Ace is displayed on the display device 360, the CPU 312 displays the manual Mnl together with the editing region Ace on the display device 360 in a state where parts of a window overlap each other (refer to a lower right portion in FIG. 12). However, a manual may be displayed in a state of not overlapping an editing region, that is, in a state of being separated from the editing region, or may be displayed instead of the editing region. Further, the entire manual may be displayed to overlap a part of the editing region.

### C. Other Forms

The present disclosure is not limited to the above-described embodiments, and can be realized in various forms without departing from the gist thereof. For example, the present disclosure can also be realized in the following forms. Technical features in the embodiments corresponding to the technical features in respective forms described below can be appropriately replaced or combined to solve some or all of the problems of the present disclosure, or achieve some or all of the effects of the present disclosure. Further, when the technical features are not described in the present specification as essential elements, the technical features can be appropriately removed.

(1) According to one form of the present disclosure, there is provided a program creation device. The program creation device includes a display device displaying a screen, an input device to which information is input by a user, and a processing device generating a screen according to the input information and causing the display device to display the screen. The processing device causes the display device to display an editing region through which a source code of a program is edited, and causes the display device to display a library creation region through which a library is created by packaging the edited source code and in which the created library is associated with a manual. The library creation region includes a manual reference region through which the manual associated with the created library is designated. The processing device further causes the display device to display a library addition region through which a previously created library is added to a new program including an edited source code and causes the display device to display a manual call region through which a manual associated with the previously created library is called.

With such an aspect, a user who edits a source code of a program by using a program creation device can designate a manual through a manual reference region when creating a library by packaging the source code. Then, the user enables the manual to be associated with the created library through a library creation region.

Further, the user who edits the source code of the program by using the program creation device can call the manual associated with the library through a manual call region. Then, the user can add, through a library addition region, the library to the program in which the source code is edited, after reading the manual and understanding a function and a usage method of the library.

(2) The program creation device according to the above-described form can have an aspect in which the processing device causes the display device to display a help tab for displaying information on a function used when a program is created by using the program creation device, and the manual call region is displayed according to an operation for the help tab.

With such an aspect, the manual call region can be displayed on the display device, and a manual can be called by the same operation as an operation when the information on the function used in creating the program is referred to.

(3) The program creation device according to the above-described form can have an aspect in which the library creation region includes a region for receiving creator information that is input through the input device and is related to a creator who creates a library through the library creation region, and the processing device causes the display device to display a region for displaying creator information of a library according to an operation on the library addition region.

With such an aspect, a user who edits a source code of a program by using the program creation device can add a library to a program in which the source code is edited through the library addition region after checking a creator of the added library.

(4) The program creation device according to the above-described form can have an aspect in which the processing device causes the display device to display the manual together with at least a part of the editing region when receiving an instruction to call the manual through the manual call region in a state where the editing region is displayed on the display device.

With such an aspect, a user who edits a source code of a program by using the program creation device can perform editing of the source code and browsing of the manual in parallel.

(5) According to another form of the present disclosure, there is provided a non-transitory computer-readable storage medium storing a computer program for creating a program by using a computer. The computer program causes a computer to realize a function of displaying, on a display device, an editing region through which a source code of a program is edited, and a function of displaying, on the display device, a library creation region through which a library is created by packaging the edited source code and in which the created library is associated with a manual. The library creation region includes a manual reference region through which the manual associated with the created library is designated. The computer program further causes the computer to realize a function of displaying, on the display device, a library addition region through which a previously created library is added to a new program including an edited source code, and a function of displaying, on the display device, a manual call region through which a manual associated with the previously created library is called.

(6) According to another form of the present disclosure, there is provided a non-transitory computer-readable storage medium storing a computer program for creating a program by using a computer. The computer program causes a computer to realize a function of displaying, on a display device, an editing region through which a source code of a program is edited, a function of displaying, on the display device, a library addition region through which a previously created library is added to a new program including an edited source code, and a function of displaying, on the display device, a manual call region through which a manual associated with the previously created library is called.

With such an aspect, a user who edits the source code of the program by using the program creation device can call the manual associated with the library through the manual call region. Then, the user can add, through a library addition region, the library to the program in which the source code is edited, after reading the manual and understanding a function and a usage method of the library.

(7) The computer program of the above-described form can have an aspect in which the computer program causes the computer to realize a function of displaying, on the display device, a help tab for displaying information on a function used when a program is created via the computer program, and the manual call region is displayed according to an operation for the help tab.

(8) The computer program of the above-described form can have an aspect in which the library creation region includes a region for receiving creator information on a creator who creates a library through the library creation region, and the computer program causes the computer to realize a function of displaying, on the display device, a region for displaying creator information of a library according to an operation on the library addition region.

(9) The computer program of the above-described form can have an aspect in which, when an instruction to call the manual is received through the manual call region in a state where the editing region is displayed on the display device, the computer program causes the computer to display the manual on the display device together with at least a part of the editing region.

The present disclosure can also be realized in various forms other than the program creation device and the computer program. For example, the present disclosure can be realized in a form of a control method of a program creation device, a non-transitory computer-readable storage medium in which a computer program is recorded, and the like.

1. A program creation device comprising:
a display device displaying a screen;
an input device to which information is input by a user; and
a processing device generating a screen according to the input information and causing the display device to display the screen, wherein
the processing device causes the display device to display an editing region through which a source code of a program is edited, and causes the display device to display a library creation region through which a library is created by packaging the edited source code and in which the created library is associated with a manual,
the library creation region includes a manual reference region through which the manual associated with the created library is designated, and
the processing device further causes the display device to display a library addition region through which a previously created library is added to a new program including an edited source code and causes the display device to display a manual call region through which a manual associated with the previously created library is called.

2. The program creation device according to claim 1, wherein
the processing device causes the display device to display a help tab for displaying information on a function used when a program is created by using the program creation device, and
the manual call region is displayed according to an operation for the help tab.

3. The program creation device according to claim 1, wherein
the library creation region includes a region for receiving creator information that is input through the input device and is related to a creator who creates a library through the library creation region, and
the processing device causes the display device to display a region for displaying creator information of a library according to an operation on the library addition region.

4. The program creation device according to claim 1, wherein
the processing device causes the display device to display the manual together with at least a part of the editing region when receiving an instruction to call the manual through the manual call region in a state where the editing region is displayed on the display device.

5. A non-transitory computer-readable storage medium storing a computer program, the computer program comprising:
causing a computer to realize a function of displaying, on a display device, an editing region through which a source code of a program is edited, and a function of displaying, on the display device, a library creation region through which a library is created by packaging the edited source code and in which the created library is associated with a manual, wherein the library creation region includes a manual reference region in which the manual associated with the created library is designated through the manual reference region; and
further causing the computer to realize a function of displaying, on the display device, a library addition region through which a previously created library is added to a new program including an edited source code, and a function of displaying, on the display device, a manual call region through which a manual associated with the previously created library is called.

6. A non-transitory computer-readable storage medium storing a computer program, the computer program comprising:
causing a computer to realize a function of displaying, on a display device, an editing region through which a source code of a program is edited, a function of displaying, on the display device, a library addition region through which a previously created library is added to a new program including an edited source code, and a function of displaying, on the display device, a manual call region through which a manual associated with the previously created library is called.

7. The non-transitory computer-readable storage medium according to claim 5, wherein
the computer program causes the computer to realize a function of displaying, on the display device, a help tab for displaying information on a function used when a program is created via the computer program, and
the manual call region is displayed according to an operation for the help tab.

8. The non-transitory computer-readable storage medium according to claim 5, wherein
the library creation region includes a region for receiving creator information on a creator who creates a library through the library creation region, and
the computer program causes the computer to realize a function of displaying, on the display device, a region for displaying creator information of a library according to an operation on the library addition region.

9. The non-transitory computer-readable storage medium according to claim 5, wherein,
when an instruction to call the manual is received through the manual call region in a state where the editing region is displayed on the display device, the computer program causes the computer to display the manual on the display device together with at least a part of the editing region.
